(19) United States
(12) Patent Application Publication
(10) Pub. No.: US 2006/0254782 A1
(43) Pub. Date: Nov. 16, 2006

(54) Inflatable horseshoe support pad

(76) Inventor: Patrick J. Morris, Santa Rosa, CA (US)

Correspondence Address: STAINBROOK & STAINBROOK, LLP, 3558 ROUND BARN BLVD., SUITE 203, SANTA ROSA, CA, 95403, US

(21) Appl. No.: 10/557,034

(22) PCT Filed: May 17, 2004
(86) PCT No.: PCT/US04/15342

§ 371 Date: Nov. 15, 2005

Related U.S. Application Data
(60) Provisional application No. 60/471,085, filed on May 15, 2003.

(51) Int. Cl. A01L 7/02

(52) U.S. Cl. 168/28

(57) ABSTRACT

An inflatable horseshoe support pad for treating laminitis and navicular syndrome, among other maladies, including a body member with a toe portion, a heel portion, an upper, hoof-facing surface and a lower, ground-facing surface. An inflatable bladder is disposed on the upper surface of the body member near the heel portion so that it engages the frog of a horse's hoof when installed on the hoof.

### TECHNICAL FIELD

The present invention relates generally to farriery, more particularly to an inflatable horse shoe support pad, and a method for use thereof, for interposition between a conventional metal horseshoe and a horse's hoof to protect and stimulate the soft tissue of the hoof and thereby to assist in the treatment of the equine diseases of laminitis and other problems of lameness.

### BACKGROUND ART

Equine founder or laminitis is a debilitating disease which, if left untreated and unarrested, may lead to progressively more serious sequella and possibly death. Disease pathology includes an inflammation and degradation of the laminae while secures the hoof wall to the coffin bone, resulting in a separation of the hoof wall from the coffin bone. The weight of the animal systematically rotates the coffin bone downwardly, while simultaneously deforming the hoof wall forwardly. Compensating for and guarding against the concomitant pain, the horse will redistribute its weight rearward and toward the heel. This simply exacerbates the problem by increasing the load on the coffin bone.

A classic reference on equine foot anatomy and pathology, The Foot of the Horse, by David Roberge, indicates that the fundamental cause of founder is an imbalance in the condition of the feet. [The Foot of the Horse, Roberge, David, pp. 180-181, Lessiter Publications, Inc., Brookfield, Wis. 2001.]

Accepted and established treatments for founder include shoeing with corrective shoes, sometimes with the addition of therapeutic pads interposed between the shoe and hoof. Numerous patents reflect the efforts of those with skill in the art to provide effective treatment for founder. Many such treatments entail the installation of a shock-absorbing pad, interposed between a horseshoe and the hoof sole, extending to cover substantially the entire hoof sole, and occasionally including surface structure to cover the frog portion of the hoof. These devices and methods of treatment provide a measure of support for the frog, however they also import several liabilities, including rapid wear and deterioration of effectiveness, exposure of the sole through the back of the heel portion to contaminants and irritating debris, or exacerbation of pathology by increased hoof imbalance. Exemplary are the following.

U.S. Pat. No. 6,283,219 to Fyer, discloses a plastic form conforming to the shape of the underside of an equine hoof and within the borders of the hoof wall that is affixed to the hoof by means of straps or adhesive tape. The function of the form is to support the sole and skeletal structure of the hoof while the hoof wall remains unsupported, the purpose being to allow the hoof wall to grow out undistorted following the occurrence of laminitis or founder. The plastic form can have additional thickness at the heel area to raise the angle of heel, reducing tension in the suspensor ligaments and flexor tendons attached to the coffin bone and thereby allowing the coffin bone to return to its normal position. The form can be cushioned to allow for sensitive hoof soles.

U.S. Pat. No. 5,509,484 to Landi et al, teaches a horseshoe shock-absorbing impact pad for horses including a generally oval-shaped panel truncated on one side to have an outer perimeter configured to correspond to the hoofprint of a horse. The panel is made of a relatively firm, resilient material, and includes a honeycomb-configured core having a first sheet of resilient material bonded to one face of the core and a second sheet of resilient material bonded to the opposite face of the core to form a plurality of hermetically sealed cells. The core comprises bonded together first and second regions. The first region having a plurality of strips of thermoplastic material having a first stiffness characteristic, bonded together along a plurality of first bond joints to form a plurality of contiguous regular shaped cells. The second region similarly having a plurality of strips of thermoplastic material having a second stiffness characteristic, bonded together along a plurality of second bond joints to form a plurality of contiguous regular shaped cells. Each of the first and the second bond joints form a first and a second bond row, respectively. Each of the first and the second bond rows are parallel to one another and are perpendicular to the longitudinal axis of the panel. When the pad is placed between a horseshoe and horse's hoof the pad tends to absorb a substantial part of the shock energy that would otherwise be transmitted to the hoof.

U.S. Pat. No. 5,167,227 to Meserlian, shows a device for massaging the legs of a horse, while also providing controllable air cushion support, includes a boot for encasing at least one foot of a horse, the boot including a flexible tube extending through the boot to permit circulation of a fluid through the boot. The flexible tube includes an inlet and an outlet. The device further includes a supply of water; an inlet conduit which supplies the water from the supply to the inlet of the flexible tube; an outlet conduit which conveys the water from the outlet of the flexible tube back to the supply; a water pump which pumps the water from the supply to the inlet conduit to control the temperature of each foot of the horse; an air pump which simultaneously pumps air from an air conduit to the inlet conduit in mixing relation with the water to such an extent that the air provides a massaging action to each foot of the horse; and an air bladder which provides regulated support for the sole of the hoof of each foot in order to aid in healing of the foot during laminitis, the air bladder being positioned within the boot and beneath the sole of the hoof of each foot; and a pressure bulb which inflates the air bladder to a desired pressure.

U.S. Pat. No. 4,794,991 to Honderich, discloses a device for the treatment of laminitis in a horse, comprising a plate member sized, shaped and adapted for fastening to the hoof of the horse, the plate member including a concave upwardly projecting portion for rotating an out of position coffin bone of the horse into its normal position and maintaining the coffin bone in the normal position for healing. The apparatus includes a U-shaped support member extending from the top of the upwardly projecting portion, for providing additional support and positioning of the coffin bone of the horse, a cushioning member, positioned on top of the plate member and the support member, for cushioning the bottom of the foot of the horse; and a bonding layer of hardened rubber for fastening the support member and the cushioning member to the plate member, the U-shaped support member being an integral portion of the bonding layer.

Many other horseshoe designs are intended to reduce shock and thereby to reduce susceptibility to injury. For instance, U.S. Pat. No. 6,488,096, to Asakawa, teaches a hoof pad used in combination with a horseshoe, with the pad having a flexible plate and a plurality of catches. The flexible plate is partially elliptically shaped to match the inner edge of the shoe. The catches are formed on the top surface of the plate and extend outwardly so that the catches can be secured on the inside of the shoe so that the plate has the same height as the top of the shoe.

U.S. Pat. No. 6,244,352 to Luber shows a shoeing apparatus comprising a shoe and shoe insert made of shock-absorbing material between the hoof and shoe. The single-part or multiple-part insert is matched to the shape of the horse shoe and is nailed in the front area between the hoof and shoe and can move in the rear area with the hoof relative to the shoe. This mobility is ensured by a sliding member situated between the insert and the shoe and capable of moving relative to the shoe. In the heel area, the insert is provided on its inner side with beading which both permits and restricts displacement of the insert.

A clever alternative to conventional horseshoe pads is disclosed in U.S. Pat. No. 6,009,952, to Porteous, et al, which teaches a method of protecting a horse hoof by injecting a synthetic organic resin such as a urethane resin in the volume defined by the horse hoof bottom wall, suitably covered with a web fixed to the hoof bottom wall that is adhered to the resin. The resin protection is suitably free flowing into place, conforms to the contours of the hoof bottom wall, and adheres to the wall when cured. The protection by the resin is resilient and softer than the hoof wall and acts to cushion the hoof against shock.

U.S. Pat. No. 5,533,575, to Brown, shows a horseshoe fabricated of elastomeric material. The shoe has a peripheral configuration corresponding to the peripheral configuration of the sole of an equidae hoof and a cross section of substantially uniform thickness. The shoe includes a tread and a ply, which has sufficient thickness and strength to hold any nails used to attach the shoe to a hoof. The shoe purportedly provides protection to the underside of the hoof, including the frog.

U.S. Pat. No. 5,303,777, to Zook, discloses a horseshoe having reinforced belting material as padding. The belting material is cut to a certain depth in selected locations and may be removed along the layers of reinforcing material. A truncated toe portion of a horseshoe is adhesively bonded to the turf side of the toe portion of the pad. The reinforcing material provides lateral stability to the padding allowing a thicker pad with the same stability. The padding may also be molded from rubber or plastic with a turf side of the toe portion recessed to accommodate the truncated horseshoe.

U.S. Pat. No. 4,565,250, to Vasko, teaches a horse shoe pad formed of a shock absorbing layer and a stabilizing fabric layer. The shock absorbing layer is a dense non-cellular polyurethane having a compression set of less than 15%, and preferably less than 5%, an elongation at break of at least 500%, a recovery after compression which is delayed by about 0.7 seconds, and a hardness on the Shore 00 scale of approximately 70. The fabric reinforcing layer may be a woven nylon fabric. In addition to these two layers, some embodiments include an additional layer of stabilizing fabric on the opposite side of the shock absorbing layer and/or layers of polyester urethane forming base and/or top layers. The pad may be used both between a plastic or a conventional metal horse shoe and the hoof, or the pad may be shaped to fit free-floatingly within the interior hoof wall and held in place only by an underlying sheet of material which is in turn secured in place by a conventional horse shoe.

Of the many designs and improvements in the art, including those detailed above, to date there is yet no known horse shoe pad providing an inflatable gas or foam filled bladder that may be interposed between a horseshoe and a horse's hoof.

### DISCLOSURE OF INVENTION

Accordingly, it is an object and advantage of the present invention to provide an improved horseshoe support pad that supports the frog.

It is a further object of the present invention to provide a horseshoe support pad that stimulates function of the digital cushion.

It is yet another object of the present invention to provide a horseshoe support pad that enhances digital circulation and stimulates growth.

It is still a further object of the present invention to provide a horseshoe support pad hat promotes normal hoof development and the optimum relationships between the toe and heel regions of the hoof.

Yet another object of the present invention is to provide an improved horseshoe support pad that maintains and re-establishes the dynamic arch of the sole.

Finally, it is an object of the present invention to provide a horseshoe support pad that provides therapeutic relief and support for diseases of the foot such as laminitis (founder) and navicular syndrome.

To achieve the foregoing objects and advantages, the present invention is an inflatable horseshoe support pad specifically adapted for use in treating laminitis and navicular syndrome. In its most essential aspect, the inventive apparatus comprises ***

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is and exploded perspective view of the elements for shoeing a horse with the inventive inflatable horse shoe pad of the present invention;

FIG. 2 is a top plan view of the inventive apparatus, showing in phantom the outer edge of a horseshoe when the shoe is in the preferred position when installed;

FIG. 3 is a bottom view of the inventive apparatus, again showing in phantom the preferred position of a horse shoe upon installation;

FIG. 4 is a side view in elevation of the inflatable horse shoe support pad;

FIG. 5 is a rear view in elevation thereof;

FIG. 6 is a cross-sectional view in elevation of the inventive apparatus installed with a horse shoe on a horse's hoof;

FIG. 7 is a cross-sectional view in elevation of the inventive horseshoe installed on a horse's foot and showing an alternative placement for the bladder valve; and

FIG. 8 is a cross-sectional side elevation view of a second preferred embodiment of the inflatable horseshoe support pad of the present invention.

### DRAWING REFERENCE NUMBERS

100 first preferred embodiment of inventive inflatable horseshoe pad
102 body member
103 toe portion
103a forwardmost point of toe portion
104 heel portion
105 upper, hoof-facing surface of body member
106 outer edge
107 lower, ground-facing surface of body member
108 inflatable bladder
110 first layer
112 second layer
114 rear side (of bladder)
116 back edge of body member
118 trimming portion
120 horseshoe
122 outside edge of horseshoe
124 hoof
126 frog pad
126a tip of frog pad
128 fore portion of the frog
130 frog
132 valve
134 passage
136 bladder chamber
200 second preferred embodiment
210 bladder portion of second preferred embodiment

### BEST MODE FOR CARRYING OUT THE INVENTION

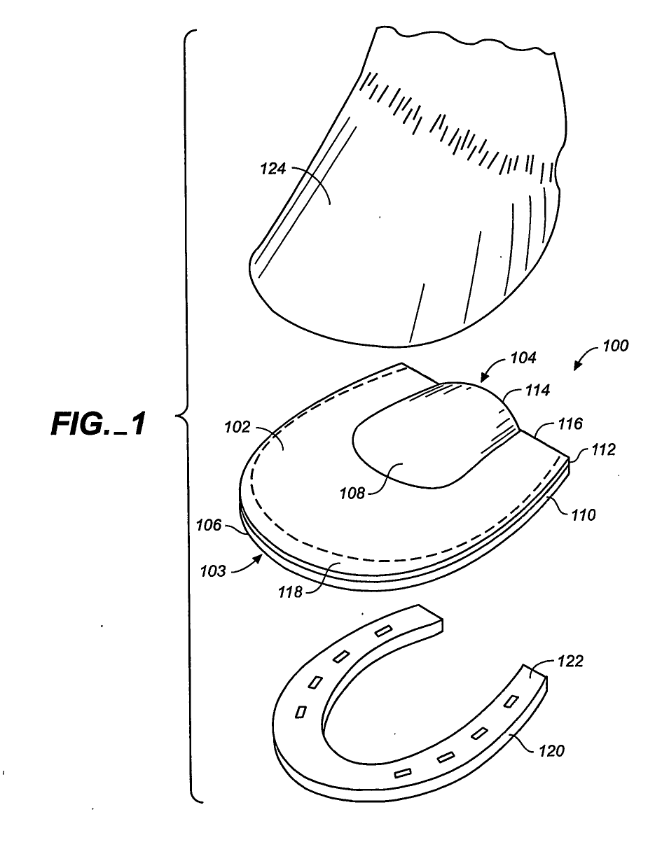

Referring to FIGS. 1 through 6, wherein like reference numerals refer to like components in the various views, there is illustrated therein a new and improved horseshoe support pad, generally denominated 100 herein.

FIG. 1 illustrates a first preferred embodiment of the inventive apparatus, showing that the pad generally comprises a substantially planar body member 102 having a toe portion 103, a heel portion 104, an upper, hoof-facing surface 105, a partially elliptical outer edge 106, a lower, ground-facing surface 107, and an inflatable bladder 108. In a first preferred embodiment, the body member comprises a first layer 110 of elastomeric material (such as rubber, including natural rubber, synthetic rubber, and/or combinations thereof), or plastic, and a second layer 112, also fabricated from elastomeric material or plastic, the second layer being welded, glued, or otherwise permanently affixed to the first layer in a manner known to those with skill in the art. Affixation of the second layer includes the entire area of the layers excluding the area defined by the bladder 108, such that the layers form a pocket for injection of gas or compressible material. Proximate the heel portion 104 of the body member, the rear side 114 of the bladder 108 extends substantially co-linearly along the back edge 116 of the body member.

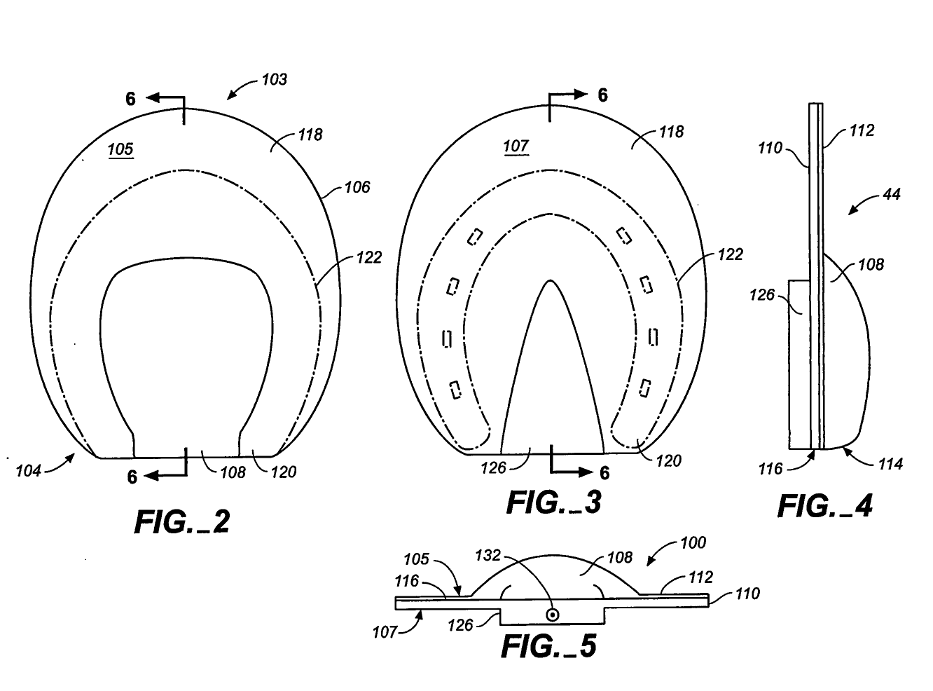

The planar body member and the inflatable bladder are sized according to the size of the hoof to be shoed. The body member preferably includes a trimming portion 118 which is intended to extend beyond the outside edge 122 of a horseshoe 120. When installed on a hoof 124, the trimming portion 118 may be cut off so that the outside edge 106 of the body member and the outside edge 122 of the shoe 120 are substantially flush. The preferred position of the horseshoe is shown in FIGS. 2 and 3.

The pad preferably includes a frog pad 126, which is generally triangular in shape and tapers from the rear edge of the body member to a point generally proximate the fore portion 128 of the frog 130 when installed. As shown in FIG. 6, a valve 132 is disposed in the rear portion of the body member, preferably in the material formed by the junction of the frog pad 126 and the first layer 110, and includes a passage 134 extending through the first and second layers to the bladder chamber 136.

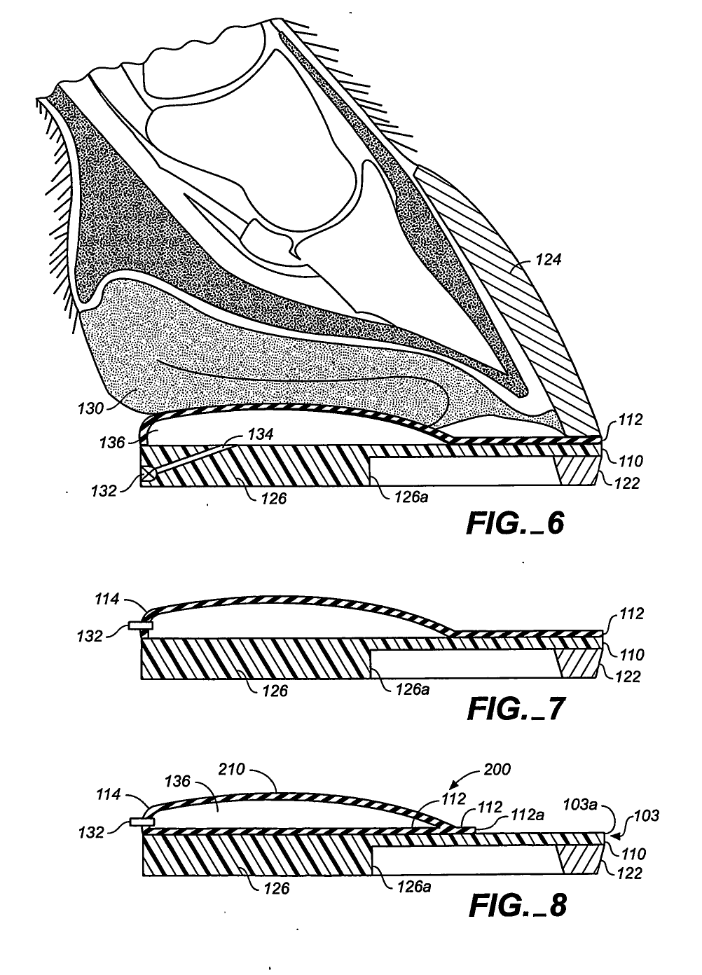

FIG. 7 shows an alternative location for the valve 132. If desired, the valve may be disposed in the rear side 114 of the bladder 108.

While each of the pad layers is preferably fabricated from resilient materials, the first layer and the frog (if integral) are fabricated of materials having a higher durometer value than that of the second layer. Additionally, the second layer may be substantially thinner than the first, which is essentially rigid relative to the second layer. Accordingly, when compressible gas or resilient material is injected into the bladder via valve 132, the bladder will fill and stretch the second layer upwardly and away from the first layer, and downward bulging in the first layer, if any at all, will be nominal.

FIG. 8 is a cross-sectional side view in elevation showing a second preferred embodiment of the inventive apparatus. In this embodiment, the second layer 112 extends under and forms the base of the bladder chamber 136. The forward most point 112a of the second layer may extend forwardly to the forward most point 103a of the toe portion 103, or it may terminate well short of that point more proximate the tip 126a of the frog pad 126. The bladder portion 210 is a discrete element and may be made to be detachable from the first layer 110 of elastomeric material. The second preferred embodiment of the inflatable horseshoe support pad of the present invention thus comprises two distinct and selectively separable pieces that form an assembly that provides the advantages described above. They can do so either as separable pieces or, alternatively, the bladder portion can be welded onto the first layer and fitted as a single piece to a horse's hoof in the shoeing process.

The two preferred embodiments of the above-described inventive apparatus may be employed therapeutically to treat hoof and leg maladies, including founder and navicular syndrome, comprising the essential steps of providing an inflatable horseshoe support pad as described above, interposing the pad between a conventional horseshoe and a hoof, inflating the bladder with compressible gas or resilient material, and refilling or releasing air as required to provide the desired frog protection and support as time passes, the hoof responds to treatment, and the hoof continues to grow. The full method of installing the therapeutic apparatus includes the steps of: (a) providing an inflatable horseshoe support pad as described in claims 1-19 above; (b) providing a horseshoe; (c) interposing the inflatable horseshoe support pad between the horseshoe and a horse's hoof so as to position the inflatable bladder chamber under the horse's frog; (d) nailing the horseshoe to the horse's hoof; (e) trimming the nail ends, as needed; (f) trimming the planar body member of the inflatable horseshoe pad so that its outside edge is substantially flush with the outside edge of the horseshoe; (g) inflating the bladder chamber with compressible gas or resilient material; and (h) refilling or releasing air as required over time to provide the desired frog protection.

As will be readily appreciated by those with skill in the art, in its most essential aspect, the inventive apparatus is an inflatable horseshoe support pad having a body member with a toe portion, a heel portion, an upper, hoof-facing surface and a lower, ground-facing surface. The inventive apparatus further includes an inflatable bladder which is disposed on the upper surface of the body member near or proximate the heel portion. When installed on a horse's hoof and inflated, the bladder engages the frog of the horse's hoof and provides supplemental cushioning when installed on the hoof, said bladder including a bladder chamber for filling with gas. The inflatable horseshoe pad could be provided to the user with the bladder pre-filled. However, it is preferable that a valve in fluid communication with the bladder chamber also be provided, so that the user can adjust bladder pressure according to the therapeutic needs and response of the horse.

The above disclosure is sufficient to enable one of ordinary skill in the art to practice the invention, and provides the best mode of practicing the invention presently contemplated by the inventor. While there is provided herein a full and complete disclosure of the preferred embodiments of this invention, it is not desired to limit the invention to the exact construction, dimensional relationships, and operation shown and described. Various modifications, alternative constructions, changes and equivalents will readily occur to those skilled in the art and may be employed, as suitable, without departing from the true spirit and scope of the invention. Such changes might involve alternative materials, components, structural arrangements, sizes, shapes, forms, functions, operational features or the like. For instance, it would be obvious to one having skill in the art to provide a different form of access to the bladder cavity than a valve. If, for instance, resilient foam were employed to provide padding rather than compressible gas, a simple flap or inlet door might function as the access means.

What is claimed as invention is:

1. An inflatable horseshoe support pad, comprising:
a body member having a toe portion, a heel portion, a back edge, a hoof-facing side and a ground-facing side;
an inflatable bladder disposed on said hoof-facing side of said body member proximate said heel portion so as to engage the frog of a horse's hoof when installed on the hoof, said bladder including a bladder chamber for inflation with gas or compressible material;
a valve in fluid communication with said bladder chamber.

2. The apparatus of claim 1, wherein said inflatable bladder and said body member are separable.

3. The apparatus of claim 1, wherein said inflatable bladder is affixed to said body member.

4. The apparatus of claim 1, wherein said body member is substantially planar and includes a first layer having an upper and a lower side, and a second layer welded to said upper side of said body member, said second layer including a bladder portion including a bladder chamber which may be inflated with gas or compressible material.

5. The apparatus of claim 4, wherein said second layer is fabricated from elastomeric material.

6. The apparatus of claim 5 wherein the elastomeric material is selected from the group consisting of natural rubber, synthetic rubber, plastic, and combinations thereof.

7. The apparatus of claim 1, wherein said bladder portion is located proximate said heel portion of the body member and includes a rear side that is substantially co-linear with the back edge of the body member.

8. The apparatus of claim 1, wherein said planar body member including a trimming portion.

9. The apparatus of claim 1, further including a frog pad disposed on said ground-facing side of said body member.

10. The apparatus of claim 9, wherein said frog pad is generally triangular and tapers inwardly from said rear edge of said body member.

11. The apparatus of claim 1, wherein said valve is disposed in said frog pad and wherein said apparatus further includes a passage placing said valve in fluid communication with said bladder chamber.

12. The apparatus of claim 11, wherein said passage is interposed between said valve and said bladder chamber and extends through said frog pad and said body member to said bladder chamber.

13. The apparatus of claim 1, wherein said valve is disposed in said bladder.

14. A therapeutic horseshoe apparatus for treatment of horse hoof and leg maladies, including founder and navicular syndrome, said apparatus comprising:
a planar body member having an upper side and a lower side; and
an inflatable bladder disposed on said upper side of said body member.

15. An apparatus as in claim 14, further including a frog pad disposed on said lower side of said body member.

16. An apparatus as in claim 14, further including fluid inlet means for inflating said inflatable bladder.

17. An apparatus as in claim 16, wherein said fluid inlet means comprises a valve disposed in said inflatable bladder.

18. An apparatus as in claim 14, wherein said bladder is integral with said body member.

19. An apparatus as in claim 18, further including a frog pad disposed on said lower side of said body member, and wherein said fluid inlet means comprises a valve disposed in said frog pad, a fluid passage extending through said frog pad and said body member and placing said inflatable bladder in fluid communication with said valve.

20. A method of treating founder and navicular syndrome in horses, said method comprising the steps of:
(a) providing an inflatable horseshoe support pad as described in claims 1-19 above;
(b) providing a horseshoe;
(c) interposing the inflatable horseshoe support pad between the horseshoe and a horse's hoof so as to position the inflatable bladder chamber under the horse's frog;
(d) nailing the horseshoe to the horse's hoof;
(e) trimming the nail ends, as needed;
(f) trimming the planar body member of the inflatable horseshoe pad so that its outside edge is substantially flush with the outside edge of the horseshoe;
(g) inflating the bladder chamber with compressible gas or resilient material; and
(h) refilling or releasing air as required over time to provide the desired frog protection.
